(19) United States
(12) Patent Application Publication
(10) Pub. No.: US 2017/0286946 A1
(43) Pub. Date: Oct. 5, 2017

(54) METHOD, APPARATUS AND COMPUTER PROGRAM PRODUCT FOR VIRTUAL CARD PAYMENT

(71) Applicant: Lenovo (Beijing) Limited, Beijing (CN)

(72) Inventors: Tao Miao, Beijing (CN); Hui Xu, Beijing (CN)

(21) Appl. No.: 15/472,532

(22) Filed: Mar. 29, 2017

(30) Foreign Application Priority Data
Mar. 29, 2016 (CN) 201610187652.X

(51) Int. Cl. G06Q 20/34; G06Q 20/40; G07F 7/08

(52) U.S. Cl. CPC G06Q 20/351; G07F 7/0806; G06Q 20/4014

(57) ABSTRACT

A method, apparatus and computer program product are disclosed. The method includes determining user information, generating a virtual card that is bound to a payment application and has a mapping relationship to a bank card, and acquiring a first parameter that includes information to verify transaction validity. The apparatus includes a communication interface, and a processor that determines user information, generates a virtual card that is bound to a payment application and has a mapping relationship to a bank card, and acquires a first parameter that includes information to verify transaction validity. The computer program product includes a computer readable storage medium that stores code to determine user information, generate a virtual card that is bound to a payment application and has a mapping relationship to a bank card, and acquires a first parameter that includes information to verify transaction validity.

### FIELD

The present disclosure relates to electronic technologies, and in particular, to an information processing method, apparatus and device.

### BACKGROUND

Online payment refers to a service in which a bank provides an online fund settlement service for a seller and a buyer when they conduct a transaction through an e-commerce website on the Internet. At present, many websites maintain their own records of credit card payment information for deduction or direct use for subsequent purchases. However, credit card information may be leaked if websites are hacked or have vulnerabilities, and purchasers must replace their credit cards after such a leak, which is costly.

### SUMMARY

Various embodiments of a method, an apparatus and a computer program product are disclosed.

The method comprises determining first information of a user holding a first bank card; generating a first virtual card for the user based on the first information; and acquiring a first parameter set by the user for the first virtual card; wherein the first virtual card is bound to at least one payment application stored on a terminal, the first virtual card has a mapping relationship with the first bank card, and the first parameter comprises information for verifying validity of a transaction process of the first virtual card.

The apparatus comprises an external communication interface; and a processor that determines first information of a user holding a first bank card, generates a first virtual card for the user based on the first information, and acquires, through the external communication interface, a first parameter set by the user for the first virtual card; wherein the first virtual card is bound to at least one payment application stored on a terminal, the first virtual card has a mapping relationship with the first bank card, and the first parameter comprises information for verifying validity of a transaction process of the first virtual card.

The computer program product comprises a computer readable storage medium that stores code executable by a processor, the executable code comprising code to perform determining first information of a user holding a first bank card; generating a first virtual card for the user based on the first information; and acquiring a first parameter set by the user for the first virtual card; wherein the first virtual card is bound to at least one payment application stored on a terminal, the first virtual card has a mapping relationship with the first bank card, and the first parameter comprises information for verifying validity of a transaction process of the first virtual card.

### BRIEF DESCRIPTION OF THE DRAWINGS

The foregoing and other objects, features and advantages of the present disclosure will become more apparent from the detailed descriptions of the embodiments of the present disclosure in conjunction with the drawings. The drawings are used to provide a further understanding of the embodiments of the present disclosure and constitute a part of the Description, which, together with the embodiments of the present disclosure, serve to explain the present disclosure and are not construed as a limitation to the present disclosure. Unless explicitly indicated, the drawings should not be understood as being drawn to scale. In the drawings, the same reference numerals generally represent the same components or steps. In the drawings:

FIG. 1 is a schematic flow diagram illustrating embodiment of an information processing method, according to Embodiment 1;

FIG. 2 is a schematic flow diagram illustrating implementation of an information processing method according to Embodiment 2;

FIG. 3 is a schematic flow diagram illustrating implementation of an information processing method according to Embodiment 3;

FIG. 4 is a schematic flow diagram illustrating implementation of an information processing method according to Embodiment 4;

FIG. 5 is a schematic flow diagram illustrating implementation of an information processing method according to Embodiment 5;

FIG. 6 is a schematic structural composition diagram of an information processing apparatus according to Embodiment 6; and

FIG. 7 is a schematic structural composition diagram of an information processing device according to Embodiment 10.

### DETAILED DESCRIPTION

The technical solution of the present disclosure is described in further detail below with reference to the accompanying drawings and specific embodiments. The embodiments provided herein are exemplary in nature, and the scope of the present disclosure is not limited to those specific embodiments detailed herein.

Embodiment 1 will now be described.

In order to solve the problems existing in the prior art, this embodiment of the present disclosure provides an information processing method, which is applied to a computing device. The function implemented by the information processing method may be implemented by invoking program codes by a processor in the computing device. Furthermore, the program codes may be stored in a computer storage medium. The computing device then includes at least the processor and the storage medium.

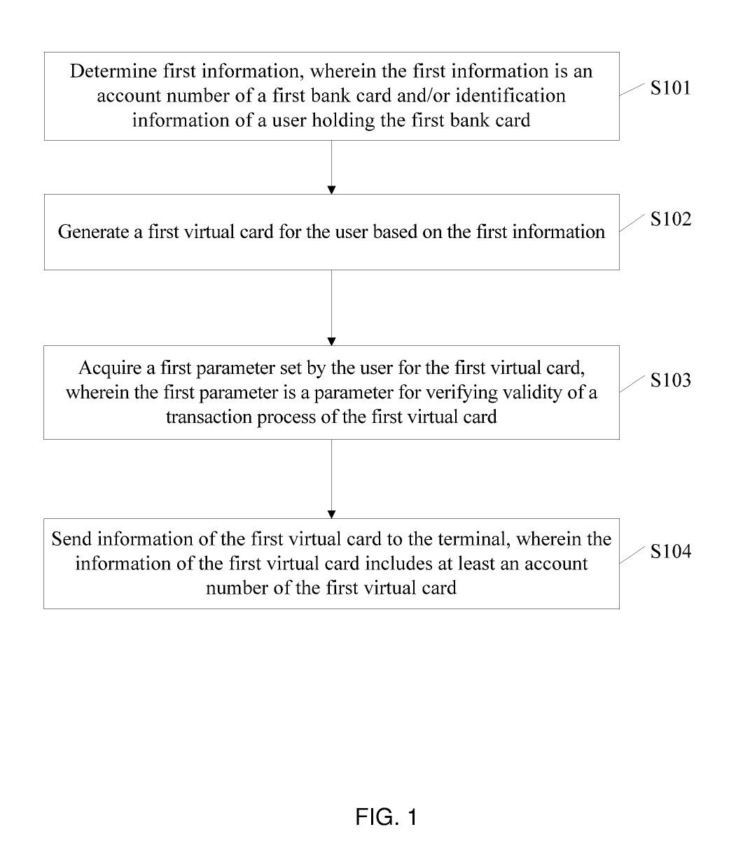

FIG. 1 is a schematic flow diagram illustrating implementation of an information processing method according to Embodiment 1. As shown in FIG. 1, the information processing method includes steps S101, S102, S103, and S104.

In Step S101 first information is determined, wherein the first information includes an account number of a first bank card and/or identification information of a user holding the first bank card.

In some embodiments, the computing device may be any type of device having information processing capabilities. For example, the computing device may be a device such as a desktop computer, a notebook computer or an integration server. In some embodiments, the computing device may be a server (a first server) of a card issuing bank that issues the first bank card. In such a case, determining first information includes: receiving, by the first server, a first request sent by a first terminal, where the first request carries at least the account number of the first bank card and/or identification information of a first user. The first terminal may be a terminal of the user, such as an electronic device such as a mobile phone, a tablet computer or a notebook computer, and the first terminal may further be a terminal configured by a bank and configured to receive user set parameters. In other words, the determined first information may be sent by the user through the user's own mobile phone, or may be managed by the user at the counter of the bank.

In some embodiments, the first bank card may be a physical bank card, and may be a bank card held by the first user. A virtual card in this embodiment of the present disclosure may have no physical form and may only have some user information of the first user. In this embodiment of the present disclosure, the first bank card is no different from an existing bank card. The only differences lie in that the virtual card in the embodiment has only one piece of user information bound to the first bank card, and the virtual card may have a real-time application function as well as a limited time allowed for use and limited options for use. For example, a limited time allowed for use may mean that the virtual card may be a one-time virtual card, and the limited options for use may mean that use is only permitted with one or two fixed merchants or recipients.

In step S102 a first virtual card in generated for the user based on the first information. In some embodiments, the first virtual card is bound to at least one payment application stored on a terminal; the first virtual card has a mapping relationship with the first bank card, and a verification process of the first virtual card in the payment-making process is different from that of the first bank card in the payment-making process.

In step S103 a first parameter set by the user for the first virtual card is acquired, wherein the first parameter is a parameter for verifying validity of a transaction process of the first virtual card. In some embodiments, the first parameter may be the number of valid transactions based on the first virtual card, or the first parameter may be recipient information of a transaction based on the first virtual card.

In step S104 information of the first virtual card is sent to the terminal, wherein the information of the first virtual card includes at least an account number of the first virtual card. In some embodiments, after the computing device sends the information of the first virtual card to the terminal, the user may complete a payment process using the information of the first virtual card. Furthermore, the terminal in step S104 may be an electronic device such as a mobile phone of the user.

In this embodiment of the present disclosure, a user can apply for a virtual bank card from a bank server. Some parameters can be set for the virtual bank card, and the parameters are used for verification in a payment process. For example, the virtual bank card may support only one payment process or payment for a specific merchant.

In this embodiment, first information is determined, where the first information may be an account number of a first bank card and/or identification information of a user holding the first bank card; a first virtual card is generated for the user based on the first information, wherein the first virtual card is used for binding to at least one payment application stored on a terminal; the first virtual card has a mapping relationship with the first bank card, and a verification process of the first virtual card in making payment is different from a verification process of the first bank card in making payment; and a first parameter set by the user for the first virtual card is acquired, where the first parameter is a parameter for verifying validity of a transaction process of the first virtual card. In this way, security can be ensured without replacing a credit card when credit card information is leaked, thereby improving user experience.

Embodiment 2 will now be described.

Based on Embodiment 1, this embodiment of the present disclosure provides an information processing method, which is applied to a computing device. The function implemented by the information processing method may be implemented by invoking program codes by a processor in the computing device. The program codes may be stored in a computer storage medium. It can be seen that the computing device includes at least the processor and the storage medium.

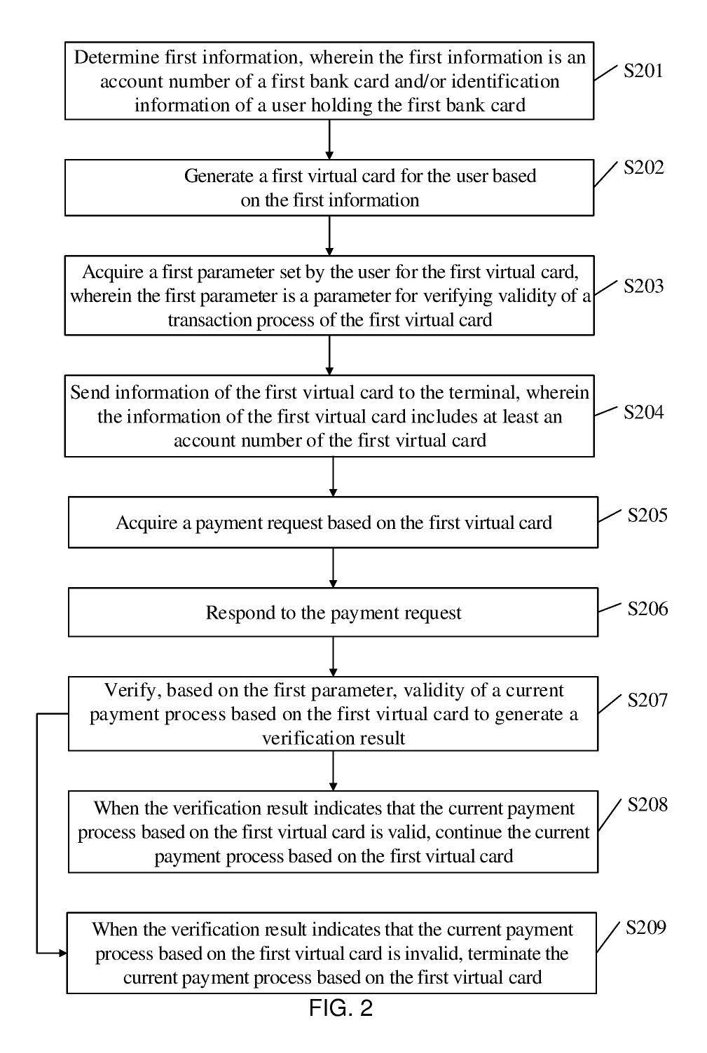

FIG. 2 is a schematic flow diagram illustrating implementation of an information processing method according to Embodiment 2. As shown in FIG. 2, the information processing method includes S201, S202, S203, S204, S205, S206, S207, S208 and S209.

In Step S201 first information is determined, wherein the first information is an account number of a first bank card and/or identification information of a user holding the first bank card.

In Step S202 a first virtual card for the user is generated based on the first information. In some embodiments, the first virtual card is bound to at least one payment application stored on a terminal; the first virtual card has a mapping relationship with the first bank card, and a verification process of the first virtual card in the payment-making process is different from that of the first bank card in the payment-making process.

In step S203 a first parameter set by the user for the first virtual card is acquired, wherein the first parameter is a parameter for verifying validity of a transaction process of the first virtual card. In some embodiments, the first parameter may be the number of valid transactions based on the first virtual card, or the first parameter may be recipient information of a transaction based on the first virtual card.

In step S204 information of the first virtual card is sent to the terminal, wherein the information of the first virtual card includes at least an account number of the first virtual card. In some embodiments, after the computing device sends the information of the first virtual card to the terminal, the user may complete a payment process using the information of the first virtual card. Furthermore, the terminal in step S104 may be an electronic device such as a mobile phone of the user.

In step S205 a payment request based on the first virtual card is acquired. In some embodiments, acquiring a payment request based on the first virtual card includes: receiving a payment request based on the first virtual card and sent by a second terminal, wherein the second terminal includes a point of sale (POS) or a terminal of the user, such as an electronic device such as a mobile phone. For example, the second terminal may be the terminal of the user, and the payment request may be a third-party payment application such as WeChat or Alipay on the mobile phone.

In some embodiments, acquiring a payment request based on the first virtual card includes: determining, by the terminal of the user, payment information; acquiring, by the terminal, the information of the first virtual card, wherein the first virtual card has a mapping relationship with the first bank card; the information of the first virtual card has a mapping relationship with information of the first bank card and the information of the first virtual card is different from the information of the first bank card; the information of the first bank card is information of the bank card held by the user corresponding to the terminal; carrying, by the terminal, the information of the first virtual card and the payment information in a payment request; and sending, by the terminal, the payment request to a server (a bank server), so that the server pays an amount corresponding to the payment information using the information of the first virtual card. The payment information includes at least a payment amount and merchant information.

In some embodiments, determining payment information by the terminal of the user includes: sending, by a server (a second server) of a recipient, a payment request that carries payment information; and receiving, by the terminal, the payment request and determining the payment information according to the payment request.

Step S206 includes responding to the payment request.

Step S207 includes verifying, based on the first parameter, validity of a current payment process based on the first virtual card to generate a verification result.

Step S208 includes continuing the current payment process based on the first virtual card when the verification result indicates that the current payment process based on the first virtual card is valid.

Step S209 includes terminating the current payment process based on the first virtual card when the verification result indicates that the current payment process based on the first virtual card is invalid.

In this embodiment of the present disclosure, a user side can apply to a bank server side for a virtual bank card, some parameters can be set for the virtual bank card, and the parameters are used for verification in a payment process. For example, the virtual bank card may support only one payment process or payment for a specific merchant.

Steps S201 to S204 in this embodiment respectively correspond to step S101 to step S104 in Embodiment 1. Therefore, those skilled in the art may understand step S201 to step S204 in this embodiment with reference to Embodiment 1, therefore details are not described herein again to save space.

Embodiment 3 will now be described.

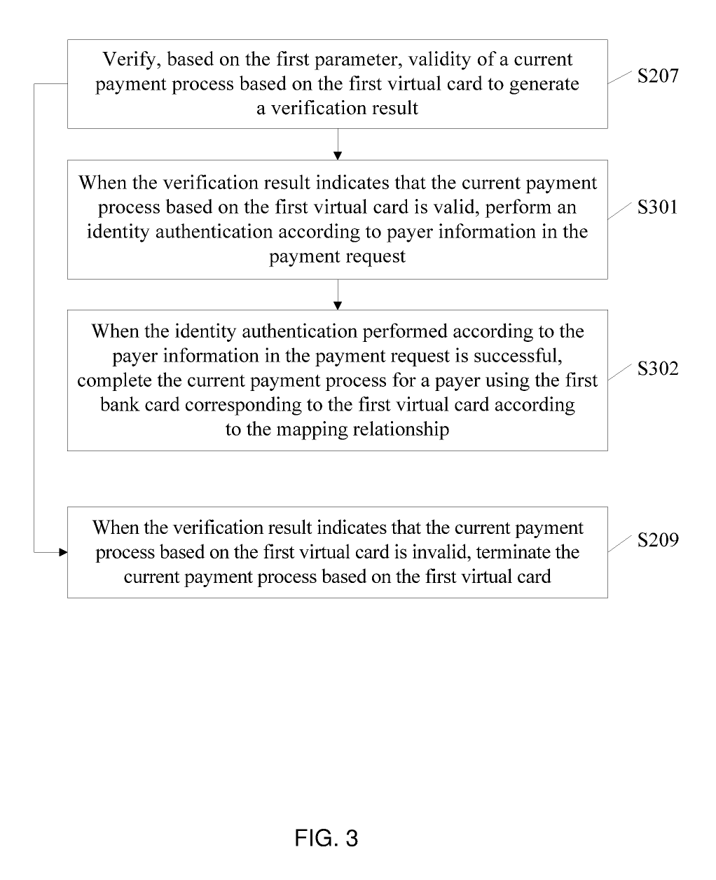

Based on Embodiment 1, this embodiment of the present disclosure provides an information processing method. FIG. 3 is a schematic flow diagram illustrating implementation of the information processing method according to Embodiment 3. As shown in FIG. 3, the information processing method includes Steps S201, S202, S203, S204, S205, S206, S207, S301, S302 and S209.

Step S201 includes determining first information, wherein the first information is an account number of a first bank card and/or identification information of a user holding the first bank card.

Step S202 includes generating a first virtual card for the user based on the first information.

In some embodiments, the first virtual card is bound to at least one payment application stored on a terminal; the first virtual card has a mapping relationship with the first bank card, and a verification process of the first virtual card in the payment-making process is different from that of the first bank card in the payment-making process.

Step S203 includes acquiring a first parameter set by the user for the first virtual card, wherein the first parameter is a parameter for verifying validity of a transaction process of the first virtual card.

In some embodiments, the first parameter is the number of valid transactions based on the first virtual card, or the first parameter is recipient information of a transaction based on the first virtual card.

Step S204 includes sending information of the first virtual card to the terminal, wherein the information of the first virtual card includes at least an account number of the first virtual card.

In some embodiments, after a computing device sends the information of the first virtual card to the terminal, the user may complete a payment process using the information of the first virtual card. In some embodiments, the terminal in step S104 may be an electronic device such as a mobile phone of the user.

Step S205 includes acquiring a payment request based on the first virtual card.

Step S206 includes responding to the payment request.

Herein, step S201 to step S206 in this embodiment correspond to step S201 to step S206 in Embodiment 2 respectively. Therefore, those skilled in the art may understand step S201 to step S206 in this embodiment with reference to Embodiment 2, therefore details are not described herein again to save space.

Step S207 Verify, based on the first parameter, validity of a current payment process based on the first virtual card to generate a verification result.

Step S301 includes, performing an identity authentication according to payer information in the payment request when the verification result indicates that the current payment process based on the first virtual card is valid.

Step S302 includes completing the current payment process for a payer using the first bank card corresponding to the first virtual card according to the mapping relationship when the identity authentication performed according to the payer information in the payment request is successful.

Step S209 includes terminating the current payment process based on the first virtual card when the verification result indicates that the current payment process based on the first virtual card is invalid.

Herein, step S301 to step S302 in this embodiment provide a manner of implementation of step S208 in Embodiment 2. In the prior art, only an identity authentication process is performed for a physical bank card, while in this embodiment of the present disclosure, validity of a payment process is verified first. The validity of the payment process is verified according to the first parameter. For example, first it is verified whether a current payment frequency of the first virtual card exceeds the payment frequency in the first parameter; and secondly, it is verified whether current payer information of the first virtual card matches payer information in the first parameter.

Embodiment 4 will now be described.

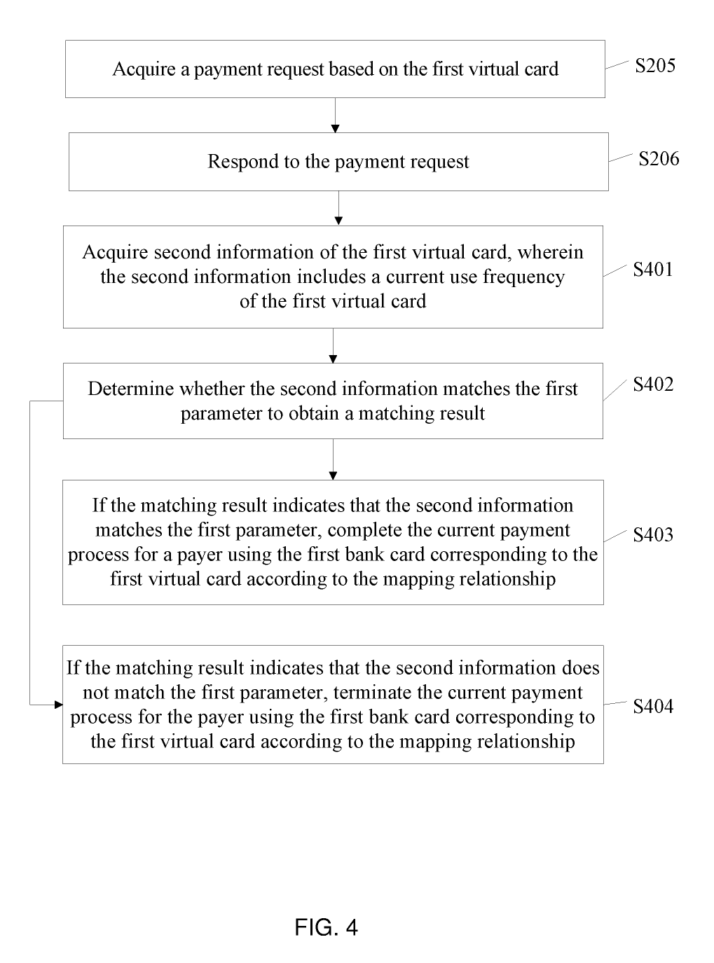

Based on Embodiment 1, this embodiment of the present disclosure provides an information processing method. FIG. 4 is a schematic flow diagram illustrating implementation of the information processing method according to Embodiment 4. As shown in FIG. 4, the information processing method includes steps S201, S202, S203, S204, S205, S206, S401, S402, S403 and S404.

Step S201 includes determining first information, wherein the first information is an account number of a first bank card and/or identification information of a user holding the first bank card.

Step S202 includes generating a first virtual card for the user based on the first information.

Step S203 includes acquiring a first parameter set by the user for the first virtual card, wherein the first parameter is a parameter for verifying validity of a transaction process of the first virtual card.

Step S204 includes sending information of the first virtual card to the terminal, wherein the information of the first virtual card includes at least an account number of the first virtual card.

Step S205 includes acquiring a payment request based on the first virtual card.

Step S206 includes responding to the payment request.

Herein, step S201 to step S206 in this embodiment correspond to step S201 to step S206 in Embodiment 2 respectively. Therefore, those skilled in the art may understand step S201 to step S206 in this embodiment with reference to Embodiment 1, therefore details are not described herein again to save space.

Step S401 includes acquiring second information of the first virtual card, wherein the second information includes a current use frequency of the first virtual card.

Step S402 includes determining whether the second information matches the first parameter to obtain a matching result.

Step S401 and step S402 provide a manner of implementing step S207, described in Embodiment 3, wherein the matching result in step S402 may be used as the verification result in step S207. The following step S403 corresponds to step S208, and step S404 corresponds to step S209.

Step S403 includes completing the current payment process for a payer using the first bank card corresponding to the first virtual card according to the mapping relationship if the matching result indicates that the second information matches the first parameter.

Step S404 includes terminating the current payment process for the payer using the first bank card corresponding to the first virtual card according to the mapping relationship if the matching result indicates that the second information does not match the first parameter.

Herein, after a bank server (a first server) completes a payment process, the bank server further sends a payment result to the terminal, and the terminal receives the payment result sent by the first server, wherein the payment result includes at least an amount credited from the first bank card; and the terminal outputs the payment result to the user. As a preferred implementation manner, the information of the first virtual card is information of the first bank card after encryption. An encryption manner may correspond to merchant information.

Embodiment 5 will now be described.

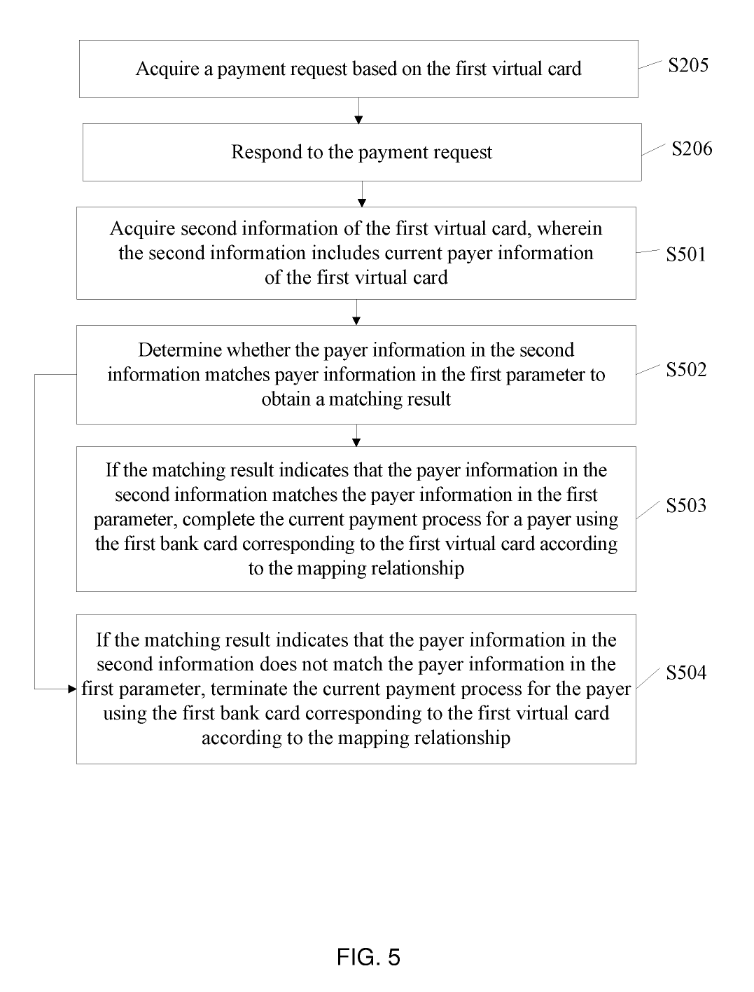

FIG. 5 is a schematic flow diagram illustrating implementation of the information processing method according to Embodiment 5. Based on Embodiment 1, this embodiment of the present disclosure provides an information processing method. The information processing method includes steps S201, S202, S203, S204, S205, S206, S501, S502, S503 and S504.

Step S201 includes determining first information, wherein the first information is an account number of a first bank card and/or identification information of a user holding the first bank card.

Step S202 includes generating a first virtual card for the user based on the first information.

Step S203 includes acquiring a first parameter set by the user for the first virtual card, wherein the first parameter is a parameter for verifying validity of a transaction process of the first virtual card.

Step S204 includes sending information of the first virtual card to the terminal, wherein the information of the first virtual card includes at least an account number of the first virtual card.

Step S205 includes acquiring a payment request based on the first virtual card.

Step S206 includes responding to the payment request.

Herein, step S201 to step S206 in this embodiment correspond to step S201 to step S206 in Embodiment 2 respectively. Therefore, those skilled in the art may understand step S201 to step S206 in this embodiment with reference to Embodiment 1, therefore details are not described herein again to save space.

Step S501 includes acquiring second information of the first virtual card, wherein the second information includes current payer information of the first virtual card.

Step S502 includes determining whether the payer information in the second information matches payer information in the first parameter to obtain a matching result.

Herein, step S501 and step S502 provide a manner of implementing step S207, described in Embodiment 3, wherein the matching result in step S502 may be used as the verification result in step S207. The following step S503 corresponds to step S208, and step S504 corresponds to step S209.

Step S503 includes completing the current payment process for a payer using the first bank card corresponding to the first virtual card according to the mapping relationship, if the matching result indicates that the payer information in the second information matches the payer information in the first parameter.

Step S504 includes terminating the current payment process for the payer using the first bank card corresponding to the first virtual card according to the mapping relationship, if the matching result indicates that the payer information in the second information does not match the payer information in the first parameter.

Embodiment 6 will now be described.

Based on the foregoing embodiments, this embodiment of the present disclosure provides an information processing apparatus. All units included in the apparatus may be implemented through an overall processor of a computing device, and certainly may also be implemented through a specific logic circuit. In different embodiments, the processor may be a central processor (CPU), a microprocessor (MPU), a digital signal processor (DSP), a field programmable gate array (FPGA), or the like.

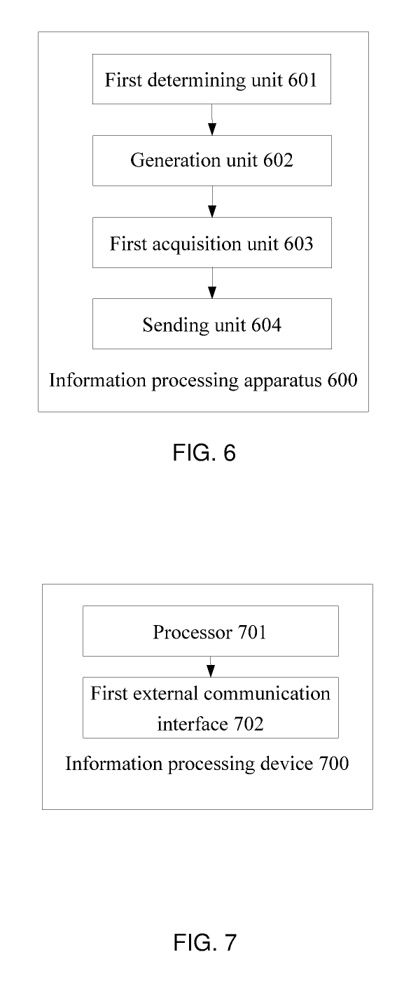

FIG. 6 is a schematic structural composition diagram of the information processing apparatus according to Embodiment 6. As shown in FIG. 6, the information processing apparatus 600 includes a first determining unit 601, a generation unit 602, a first acquisition unit 603, and a sending unit 604.

The first determining unit is configured to determine first information, wherein the first information is an account number of a first bank card and/or identification information of a user holding the first bank card.

In some embodiments, the first determining unit 601 is configured to receive a first request sent by a first terminal, wherein the first request carries at least the account number of the first bank card and/or identification information of a first user.

The generation unit 602 is configured to generate a first virtual card for the user based on the first information, wherein the first virtual card is bound to at least one payment application stored on a terminal. The first virtual card has a mapping relationship with the first bank card, and a verification process of the first virtual card in the payment-making process is different from that of the first bank card in in the payment-making process.

The first acquisition unit 603 is configured to acquire a first parameter set by the user for the first virtual card, wherein the first parameter is a parameter for verifying validity of a transaction process of the first virtual card.

In some embodiments, the first parameter is the number of valid transactions based on the first virtual card, or the first parameter is recipient information of a transaction based on the first virtual card.

The sending unit 604 is configured to send information of the first virtual card to the terminal, wherein the information of the first virtual card includes at least an account number of the first virtual card.

It should be noted herein that the above embodiment is described similarly to the foregoing method embodiment, and has similar beneficial effects to those of the method embodiment, thus details are not described again. Technical details not disclosed in the apparatus embodiment of the present disclosure may be understood with reference to the description of the method embodiment of the present disclosure, and thus details are not described again to save space.

Embodiment 7 will now be described.

Based on the foregoing embodiment, this embodiment of the present disclosure provides an information processing apparatus. All units included in the apparatus and modules included in each unit may be implemented through an overall processor of a computing device, and certainly may also be implemented through a specific logic circuit. In the process of a specific embodiment, the processor may be a central processor (CPU), a microprocessor (MPU), a digital signal processor (DSP), a field programmable gate array (FPGA), or the like.

The information processing apparatus includes a first determining unit, a generation unit, a first acquisition unit, a sending unit, a second acquisition unit, a response unit, a verification unit, a continuation unit, and a termination unit.

The first determining unit is configured to determine first information, wherein the first information is an account number of a first bank card and/or identification information of a user holding the first bank card.

The first determining unit is configured to receive a first request sent by a first terminal, where the first request carries at least the account number of the first bank card and/or identification information of a first user.

The generation unit is configured to generate a first virtual card for the user based on the first information, wherein the first virtual card is bound to at least one payment application stored on a terminal; the first virtual card has a mapping relationship with the first bank card, and a verification process of the first virtual card in in the payment-making process is different from that of the first bank card in in the payment-making process.

The first acquisition unit is configured to acquire a first parameter set by the user for the first virtual card, wherein the first parameter is a parameter for verifying validity of a transaction process of the first virtual card.

In some embodiments, the first parameter may be the number of valid transactions based on the first virtual card. In some embodiments, the first parameter may be recipient information of a transaction based on the first virtual card.

The sending unit is configured to send information of the first virtual card to the terminal, wherein the information of the first virtual card includes at least an account number of the first virtual card.

The second acquisition unit is configured to acquire a payment request based on the first virtual card.

The response unit is configured to respond to the payment request.

The verification unit is configured to verify, based on the first parameter, validity of a current payment process based on the first virtual card to generate a verification result.

The continuation unit is configured to, when the verification result indicates that the current payment process based on the first virtual card is valid, continue the current payment process based on the first virtual card.

The termination unit is configured to, when the verification result indicates that the current payment process based on the first virtual card is invalid, terminate the current payment process based on the first virtual card.

Herein, the continuation unit includes a verification module and a completion module.

The verification module is configured to, perform an identity authentication according to payer information in the payment request when the verification result indicates that the current payment process based on the first virtual card is valid.

The completion module is configured to complete the current payment process for a payer using the first bank card corresponding to the first virtual card according to the mapping relationship when the identity authentication performed according to the payer information in the payment request is successful.

It should be noted herein that the apparatus embodiment above is described similarly to the foregoing method embodiments, and has similar beneficial effects to those of the method embodiment, thus details are not described again. Technical details not disclosed in the apparatus embodiment of the present disclosure may be understood with reference to the description of the method embodiment of the present disclosure, and thus details are not described again to save space.

Embodiment 8 will now be described.

Based on the foregoing embodiment 7, this embodiment of the present disclosure provides an information processing apparatus. All units included in the apparatus and modules included in each unit may be implemented through an overall processor of a computing device, and may also be implemented through a specific logic circuit. In some embodiments, the processor may be a central processor (CPU), a microprocessor (MPU), a digital signal processor (DSP), a field programmable gate array (FPGA), or the like.

The information processing apparatus includes a first determining unit, a generation unit, a first acquisition unit, a sending unit, a second acquisition unit, a response unit, a verification unit, a continuation unit, and a termination unit.

The first determining unit is configured to determine first information, wherein the first information is an account number of a first bank card and/or identification information of a user holding the first bank card.

Herein, the first determining unit is configured to receive a first request sent by a first terminal, wherein the first request carries at least the account number of the first bank card and/or identification information of a first user.

The generation unit is configured to generate a first virtual card for the user based on the first information, wherein the first virtual card is bound to at least one payment application stored on a terminal; the first virtual card has a mapping relationship with the first bank card, and a verification process of the first virtual card in the payment-making process is different from that of the first bank card in in the payment-making process.

The first acquisition unit is configured to acquire a first parameter set by the user for the first virtual card, wherein the first parameter is a parameter for verifying validity of a transaction process of the first virtual card.

In some embodiments, the first parameter may be the number of valid transactions based on the first virtual card. Alternatively, in some embodiments, the first parameter may be recipient information of a transaction based on the first virtual card.

The sending unit is configured to send information of the first virtual card to the terminal, wherein the information of the first virtual card includes at least an account number of the first virtual card.

The second acquisition unit is configured to acquire a payment request based on the first virtual card.

The response unit is configured to respond to the payment request.

The verification unit is configured to acquire second information of the first virtual card, wherein the second information includes a current use frequency of the first virtual card; and determine whether the second information matches the first parameter to obtain a matching result as a verification result.

The continuation unit is configured to, if the matching result indicates that the second information matches the first parameter, complete the current payment process for a payer using the first bank card corresponding to the first virtual card according to the mapping relationship.

The termination unit is configured t terminate the current payment process for the payer using the first bank card corresponding to the first virtual card according to the mapping relationship if the matching result indicates that the second information does not match the first parameter.

It should be noted herein that the apparatus embodiment above is described similarly to the foregoing method embodiment, and has similar beneficial effects to those of the method embodiment, thus details are not described again. Technical details not disclosed in the apparatus embodiment of the present disclosure may be understood with reference to the description of the method embodiment of the present disclosure, and thus details are not described again to save space.

Embodiment 9 will now be described.

Based on the foregoing embodiment 7, this embodiment of the present disclosure provides an information processing apparatus. All units included in the apparatus and modules included in each unit may be implemented through an overall processor of a computing device, and certainly may also be implemented through a specific logic circuit. In some embodiments, the processor may be a central processor (CPU), a microprocessor (MPU), a digital signal processor (DSP), a field programmable gate array (FPGA), or the like.

The information processing apparatus includes a first determining unit, a generation unit, a first acquisition unit, a sending unit, a second acquisition unit, a response unit, a verification unit, a continuation unit, and a termination unit.

The first determining unit determines first information, wherein the first information is an account number of a first bank card and/or identification information of a user holding the first bank card.

In some embodiments, the first determining unit receives a first request sent by a first terminal, wherein the first request carries at least the account number of the first bank card and/or identification information of a first user.

The generation unit generates a first virtual card for the user based on the first information, wherein the first virtual card is bound to at least one payment application stored on a terminal. The first virtual card has a mapping relationship with the first bank card, and a verification process of the first virtual card in the payment-making process is different from that of the first bank card in the payment-making process.

The first acquisition unit acquires a first parameter set by the user for the first virtual card, wherein the first parameter is a parameter for verifying validity of a transaction process of the first virtual card.

In some embodiments, the first parameter is the number of valid transactions based on the first virtual card. Alternatively, in some embodiments the first parameter is recipient information of a transaction based on the first virtual card.

The sending unit sends information of the first virtual card to the terminal, wherein the information of the first virtual card includes at least an account number of the first virtual card.

The second acquisition unit acquires a payment request based on the first virtual card.

The response unit responds to the payment request.

The verification unit acquires second information of the first virtual card, wherein the second information includes current payer information of the first virtual card; and determines whether the payer information in the second information matches payer information in the first parameter to obtain a matching result.

The continuation unit completes the current payment process for a payer using the first bank card corresponding to the first virtual card according to the mapping relations if the matching result indicates that the payer information in the second information matches the payer information in the first parameter.

The termination unit terminates (or ends) the current payment process for the payer using the first bank card corresponding to the first virtual card according to the mapping relationship if the matching result indicates that the payer information in the second information does not match the payer information in the first parameter.

It should be noted herein that the apparatus embodiment above is described similarly to the foregoing method embodiment, and has similar beneficial effects to those of the method embodiment, thus details are not described again. Technical details not disclosed in the apparatus embodiment of the present disclosure may be understood with reference to the description of the method embodiment of the present disclosure, and thus details are not described again to save space.

Embodiment 10 will now be described.

Based on the foregoing embodiment, this embodiment of the present disclosure provides an information processing device (a computing device). FIG. 7 is a schematic structural composition diagram of the information processing device according to Embodiment 10 of the present disclosure. As shown in FIG. 7, the information processing device 700 includes a processor 701 and a first external communication interface 702.

The processor 701 also determines first information, wherein the first information is an account number of a first bank card and/or identification information of a user holding the first bank card.

The processor 701 also generates a first virtual card for the user based on the first information, wherein the first virtual card is bound to at least one payment application stored on a terminal. The first virtual card has a mapping relationship with the first bank card, and a verification process of the first virtual card in the payment-making process is different from that of the first bank card in the payment-making process.

The processor 701 also acquires, through the first external communication interface 702, a first parameter set by the user for the first virtual card, wherein the first parameter is a parameter for verifying validity of a transaction process of the first virtual card.

The electronic device 700 further includes a second external communication interface. Determining first information includes: receiving, through the second external communication interface, a first request sent by a first terminal, wherein the first request carries at least the account number of the first bank card and/or identification information of a first user.

In some embodiments, the processor 701 is configured to send information of the first virtual card to the terminal, wherein the information of the first virtual card includes at least an account number of the first virtual card.

In some embodiments, the first parameter may be the number of valid transactions based on the first virtual card. Alternatively, in some embodiments, the first parameter may be recipient information of a transaction based on the first virtual card.

It should be noted herein that the electronic device embodiment above is described similarly to the foregoing method, and has the same beneficial effects as those of the method embodiment, thus details are not described again. Technical details not disclosed in the electronic device embodiment of the present disclosure may be understood by those skilled in the art with reference to the description of the method embodiment of the present disclosure, therefore details are not described herein again to save space.

Embodiment 11 will now be described.

Based on the foregoing embodiment, this embodiment of the present disclosure provides an information processing device. With reference to FIG. 7, the information processing device 700 includes a processor 701 and a first external communication interface 702.

The processor 701 determines first information, wherein the first information is an account number of a first bank card and/or identification information of a user holding the first bank card;

The processor 701 also generates a first virtual card for the user based on the first information, wherein the first virtual card is bound to at least one payment application stored on a terminal; the first virtual card has a mapping relationship with the first bank card, and a verification process of the first virtual card in the payment-making process is different from that of the first bank card in the payment-making process.

The processor 701 also: acquires, through the first external communication interface 702, a first parameter set by the user for the first virtual card, wherein the first parameter is a parameter for verifying validity of a transaction process of the first virtual card; acquires a payment request based on the first virtual card; responds to the payment request; verifies, based on the first parameter, validity of a current payment process based on the first virtual card to generate a verification result; continues the current payment process based on the first virtual card when the verification result indicates that the current payment process based on the first virtual card is valid; and terminates the current payment process based on the first virtual card when the verification result indicates that the current payment process based on the first virtual card is invalid.

In some embodiments, the electronic device further includes a second external communication interface. In some embodiments, determining first information includes: receiving, through the second external communication interface, a first request sent by a first terminal, wherein the first request carries at least the account number of the first bank card and/or identification information of a first user.

In some embodiments, the processor is configured to send information of the first virtual card to the terminal, wherein the information of the first virtual card includes at least an account number of the first virtual card.

In some embodiments, the first parameter is the number of valid transactions based on the first virtual card, or the first parameter is recipient information of a transaction based on the first virtual card.

In some embodiments of the present disclosure, after the verification result indicates that the current payment process based on the first virtual card is valid, continuing the current payment process based on the first virtual card includes: after the verification result indicates that the current payment process based on the first virtual card is valid, performing an identity authentication according to payer information in the payment request; and when the identity authentication performed according to the payer information in the payment request is successful, completing the current payment process for a payer using the first bank card corresponding to the first virtual card according to the mapping relationship.

It should be noted herein that the electronic device embodiment above is described similarly to the foregoing method, and has the same beneficial effects as those of the method embodiment, thus some details are not described again. Technical details not disclosed in the electronic device embodiment of the present disclosure may be understood by those skilled in the art with reference to the description of the method embodiment of the present disclosure, therefore details are not described herein again to save space.

Embodiment 12 will now be described.

Based on the foregoing embodiment, this embodiment of the present disclosure provides an information processing device (a computing device). With reference to FIG. 7, the information processing device 700 includes a processor 701 and a first external communication interface 702. The processor is configured to:

The processor 701 determines first information, wherein the first information is an account number of a first bank card and/or identification information of a user holding the first bank card.

The processor 701 generates a first virtual card for the user based on the first information, where the first virtual card is bound to at least one payment application stored on a terminal; the first virtual card has a mapping relationship with the first bank card, and a verification process of the first virtual card in the payment-making process is different from that of the first bank card in in the payment-making process.

The processor 701 acquires, through the first external communication interface 702, a first parameter set by the user for the first virtual card, wherein the first parameter is a parameter for verifying validity of a transaction process of the first virtual card.

The processor 701 also acquires a payment request based on the first virtual card; responds to the payment request; acquires second information of the first virtual card, wherein the second information includes a current number of times the first virtual card is used; determines whether the second information matches the first parameter to obtain a matching result; completes the current payment process for a payer using the first bank card corresponding to the first virtual card according to the mapping relationship if the matching result indicates that the second information matches the first parameter; and terminates the current payment process for the payer using the first bank card corresponding to the first virtual card according to the mapping relationship if the matching result indicates that the second information does not match the first parameter.

It should be noted herein that the electronic device embodiment above is described similarly to the foregoing method, and has the same beneficial effects as those of the method embodiment, thus details are not described again. Technical details not disclosed in the electronic device embodiment of the present disclosure may be understood by those skilled in the art with reference to the description of the method embodiment of the present disclosure, therefore details are not described herein again to save space.

Embodiment 13 will now be described.

Based on the foregoing embodiment, this embodiment of the present disclosure provides an information processing device (a computing device). With reference to FIG. 7, the information processing device 700 includes a processor 701 and a first external communication interface 702.

The processor 701 determines first information, wherein the first information is an account number of a first bank card and/or identification information of a user holding the first bank card.

The processor 701 also generates a first virtual card for the user based on the first information, where the first virtual card is bound to at least one payment application stored on a terminal; the first virtual card has a mapping relationship with the first bank card, and a verification process of the first virtual card in the payment-making process is different from that of the first bank card in the payment-making process.

The processor 701 further acquires, through the first external communication interface 702, a first parameter set by the user for the first virtual card, wherein the first parameter is a parameter for verifying validity of a transaction process of the first virtual card.

The processor 701 also acquires a payment request based on the first virtual card; responds to the payment request; acquires second information of the first virtual card, wherein the second information includes current payer information of the first virtual card; determines whether the payer information in the second information matches payer information in the first parameter to obtain a matching result; completes the current payment process for a payer using the first bank card corresponding to the first virtual card according to the mapping relationship if the matching result indicates that the payer information in the second information matches the payer information in the first parameter; and terminate the current payment process for the payer using the first bank card corresponding to the first virtual card according to the mapping relationship if the matching result indicates that the payer information in the second information does not match the payer information in the first parameter.

It should be noted herein that the electronic device embodiment above is described similarly to the foregoing method, and has the same beneficial effects as those of the method embodiment, thus details are not described again. Technical details not disclosed in the electronic device embodiment of the present disclosure may be understood by those skilled in the art with reference to the description of the method embodiment of the present disclosure, therefore details are not described herein again to save space.

It should be understood that reference throughout the specification to “one embodiment” or “an embodiment” means that particular features, structures or characteristics in connection with the embodiment are included in at least one embodiment of the present subject matter. Therefore, the phrases “in one embodiment” or “in an embodiment” appearing in various places throughout the specification do not necessarily refer to the same embodiment. Furthermore, the particular features, structures or characteristics may be combined in any suitable manner in one or more embodiments. It should be understood that the foregoing sequence numbers of the processes do not imply an execution order of the processes in various embodiments of the present disclosure, and the execution order of the processes should be determined according to their functions and internal logic, and should not constitute any limitation to the implementation process of the embodiment of the present disclosure. The foregoing sequence numbers of the embodiments of the present disclosure are merely for the convenience of description, and do not imply any preference among the embodiments.

It should be noted that the terms “include”, “comprise” and any variants thereof are intended to encompass nonexclusive inclusion herein, so that a process, a method, an article or an apparatus including a series of elements includes not only those elements but also other elements that are not listed explicitly or elements inherent to the process, the method, the article or the apparatus. Without more restrictions, an element defined by the sentence “include/comprise a(n) . . . ” will not exclude the presence of additional identical elements in the process, the method, the article or the apparatus including the element.

In the several embodiments provided in the present application, it should be understood that the disclosed device and method may be implemented in other manners. The device embodiments described above are merely exemplary. For example, the division of units herein is merely logical function division and other divisions may be used in actual implementation. For example, multiple units or components may be combined or integrated into another system, or some features may be ignored or not performed. In addition, the displayed or discussed mutual couplings or direct couplings or communication connections between the constituent parts may be implemented through some interfaces. The indirect couplings or communication connections between the devices or units may be implemented in electrical, mechanical, or other forms.

The units described as separate parts may or may not be physically separated. The parts displayed as units may or may not be physical units, and may be located at one place or distributed on multiple network units. Some or all of the units may be selected to achieve the objective of the solution of the embodiment according to actual demands.

In addition, the functional units in the embodiments of the present disclosure may be integrated into one processing unit or each of the units may be used alone as a unit, or two or more units may be integrated into one unit. The integrated unit may be implemented in the form of hardware or implemented in the form of hardware plus a software functional unit.

Those of ordinary skill in the art should understand that all or some of the steps for implementing the method embodiments may be implemented by a program instructing relevant hardware. The program may be stored in a computer readable storage medium. When the program is run, the steps of the method embodiments are performed. The storage medium includes any medium that is capable of storing program codes, such as a mobile storage device, a read-only memory (ROM), a magnetic disk, or an optical disc.

Alternatively, when being implemented in the form of a software functional unit and sold or used as a separate product, the integrated unit in the present disclosure may also be stored in a computer readable storage medium. Based on such understanding, the essence of the technical solution of the embodiments of the present disclosure or the part that makes contributions to the prior art may be embodied in the form of a software product. The computer software product is stored in a storage medium and includes several instructions for instructing a computer device (which may be a personal computer, a server, a network device, or the like) to perform all or part of the method described in the embodiments of the present disclosure. The storage medium includes any medium that is capable of storing program codes, such as a mobile storage device, a ROM, a magnetic disk, or an optical disc.

The above descriptions are merely specific manners of implementation of the present subject matter, but the scope of protection of the present disclosure is not limited thereto. Variations or modifications readily apparent to those skilled in the art within the technical scope disclosed by the present disclosure shall fall within the protection scope of the present disclosure. Therefore, the protection scope of the present disclosure is subject to the appended claims.

What is claimed is:

1. An information processing method, comprising
determining first information of a user holding a first bank card;
generating a first virtual card for the user based on the first information; and
acquiring a first parameter set by the user for the first virtual card;
wherein
the first virtual card is bound to at least one payment application stored on a terminal,
the first virtual card has a mapping relationship with the first bank card, and
the first parameter comprises information for verifying validity of a transaction process of the first virtual card.

2. The method of claim 1, wherein
the first information comprises an account number corresponding to the first bank card; and
determining first information of a user holding a first bank card comprises receiving a first request sent by a first terminal;
wherein the first request carries the account number corresponding to the first bank card.

3. The method of claim 1, wherein
the first information comprises identification information of the user holding the first bank card;
determining first information comprises receiving a first request sent by a first terminal;
the first request carries the identification information of the user holding the first bank card.

4. The method of claim 1, wherein the method further comprises:
sending information of the first virtual card to the terminal;
wherein the information of the first virtual card comprises an account number corresponding to the first virtual card.

5. The method of claim 1, wherein the method further comprises:
acquiring a payment request based on the first virtual card;
responding to the payment request;
verifying, based on the first parameter, validity of a current payment process based on the first virtual card to generate a verification result;
continuing the current payment process based on the first virtual card if a verification result indicates that the current payment process based on the first virtual card is valid; and
terminating the current payment process based on the first virtual card if the verification result indicates that the current payment process based on the first virtual card is invalid.

6. The method of claim 5, wherein continuing the current payment process based on the first virtual card if the verification result indicates that the current payment process based on the first virtual card is valid comprises:
performing an identity authentication according to payer information in the payment request if the verification result indicates that the current payment process based on the first virtual card is valid; and
completing the current payment process using the first bank card corresponding to the first virtual card according to the mapping relationship after the identity authentication performed according to the payer information in the payment request is successful.

7. The method of claim 5, wherein
the first parameter comprises a number of allowed transactions to be made with the first virtual card;
second information of the first virtual card comprises a current number of transactions made with the first virtual card; and
verifying, based on the first parameter, validity of a current payment process based on the first virtual card to generate a verification result comprises:
acquiring the second information of the first virtual card,
obtaining a compliance result based on a determination of whether the current number of transactions made with the virtual card of the second information is less than the number of allowed transactions to be made with the first virtual card,
using the compliance result as the verification result,
completing the current payment process for the payer using the first bank card corresponding to the first virtual card according to the mapping relationship if the compliance result indicates that the current number of transactions made with the virtual card is less than the number of allowed transactions to be made with the first virtual card, and
terminating the current payment process for the payer using the first bank card corresponding to the first virtual card according to the mapping relationship if the compliance result indicates that the current number of transactions made with the virtual card is not less than the number of allowed transactions to be made with the first virtual card.

8. The method of claim 5, wherein
the first parameter comprises payer information;
second information of the first virtual card comprises current payer information of the first virtual card; and
verifying, based on the first parameter, validity of a current payment process based on the first virtual card to generate a verification result comprises acquiring the second information of the first virtual card,
obtaining a matching result based on a determination of whether the current payer information of the first virtual card of the second information matches the payer information of the first parameter;
using the matching result as the verification result,
completing the current payment process using the first bank card corresponding to the first virtual card according to the mapping relationship if the matching result indicates that the current payer information of the first virtual card matches the payer information in the first parameter; and
terminating the current payment process using the first bank card corresponding to the first virtual card according to the mapping relationship if the matching result indicates that the current payer information of the first virtual card in the second information does not match the payer information in the first parameter.

9. An apparatus, comprising
an external communication interface; and
a processor that
determines first information of a user holding a first bank card,
generates a first virtual card for the user based on the first information, and
acquires, through the external communication interface, a first parameter set by the user for the first virtual card;
wherein
the first virtual card is bound to at least one payment application stored on a terminal,
the first virtual card has a mapping relationship with the first bank card, and
the first parameter comprises information for verifying validity of a transaction process of the first virtual card.

10. The apparatus of claim 9, wherein
the first information comprises an account number corresponding to the first bank card;
the processor determines first information by receiving a first request sent by a first terminal; and
the first request carries the account number corresponding to the first bank card.

11. The apparatus of claim 9, wherein
the first information comprises identification information of the user holding the first bank card;
the processor determines first information by receiving a first request sent by a first terminal; and
the first request carries the identification information of the user holding the first bank card.

12. The apparatus of claim 9, wherein
the processor sends, through the external communication interface, information of the first virtual card to the terminal;
wherein the information of the first virtual card comprises an account number corresponding to the first virtual card.

13. The apparatus of claim 9, wherein the processor
acquires, through the external communication interface, a payment request based on the first virtual card;
responds to the payment request;
verifies, based on the first parameter, validity of a current payment process based on the virtual card to generate a verification result;
continues the current payment process based on the first virtual card if a verification result indicates that the current payment process based on the first virtual card is valid; and
terminates the current payment process based on the first virtual card if the verification result indicates that the current payment process based on the first virtual card is invalid.

14. The apparatus of claim 13, wherein the processor continues the current payment process based on the first virtual card if a verification result indicates that the current payment process based on the first virtual card is valid by
performing an identity authentication according to payer information in the payment request if the verification result indicates that the current payment process based on the first virtual card is valid; and
completing the current payment process using the first bank card corresponding to the first virtual card according to the mapping relationship after the identity authentication performed according to the payer information in the payment request is successful.

15. The apparatus of claim 13, wherein
the first parameter comprises a number of allowed transactions to be made with the first virtual card;
second information of the first virtual card comprises a current number of transactions made with the first virtual card; and
the processor verifies, based on the first parameter, validity of a current payment process based on the virtual card to generate a verification result by
acquiring the second information of the first virtual card,
obtaining a compliance result based on a determination of whether the current number of transactions made with the virtual card of the second information is less than the number of allowed transactions to be made with the first virtual card,
using the compliance result as the verification result,
completing the current payment process for the payer using the first bank card corresponding to the first virtual card according to the mapping relationship if the compliance result indicates that the current number of transactions made with the virtual card is less than the number of allowed transactions to be made with the first virtual card, and
terminating the current payment process for the payer using the first bank card corresponding to the first virtual card according to the mapping relationship if the compliance result indicates that the current number of transactions made with the virtual card is not less than the number of allowed transactions to be made with the first virtual card.

16. The apparatus of claim 13, wherein
the first parameter comprises payer information;
second information of the first virtual card comprises current payer information of the first virtual card; and
the processor verifies, based on the first parameter, validity of a current payment process based on the virtual card to generate a verification result by
acquiring the second information of the first virtual card,
obtaining a matching result based on a determination of whether the current payer information of the first virtual card of the second information matches the payer information of the first parameter;
using the matching result as the verification result,
completing the current payment process using the first bank card corresponding to the first virtual card according to the mapping relationship if the matching result indicates that the current payer information of the first virtual card matches the payer information in the first parameter; and
terminating the current payment process using the first bank card corresponding to the first virtual card according to the mapping relationship if the matching result indicates that the current payer information of the first virtual card in the second information does not match the payer information in the first parameter.

17. A computer program product comprising a computer readable storage medium that stores code executable by a processor, the executable code comprising code to perform
determining first information of a user holding a first bank card;
generating a first virtual card for the user based on the first information; and
acquiring a first parameter set by the user for the first virtual card;
wherein
the first virtual card is bound to at least one payment application stored on a terminal,
the first virtual card has a mapping relationship with the first bank card, and
the first parameter comprises information for verifying validity of a transaction process of the first virtual card.

18. The computer program product of claim 17, further comprising code to perform sending information of the first virtual card to the terminal;
wherein the information of the first virtual card comprises an account number corresponding to the first virtual card.

19. The computer program product of claim 17, further comprising code to perform acquiring a payment request based on the first virtual card;
responding to the payment request;
verifying, based on the first parameter, validity of a current payment process based on the first virtual card to generate a verification result;
continuing the current payment process based on the first virtual card if a verification result indicates that the current payment process based on the first virtual card is valid; and
terminating the current payment process based on the first virtual card if the verification result indicates that the current payment process based on the first virtual card is invalid.

20. The computer program product of claim 19, wherein continuing the current payment process based on the first virtual card if a verification result indicates that the current payment process based on the first virtual card is valid comprises
performing an identity authentication according to payer information in the payment request if the verification result indicates that the current payment process based on the first virtual card is valid; and
completing the current payment process using the first bank card corresponding to the first virtual card according to the mapping relationship after the identity authentication performed according to the payer information in the payment request is successful.
